(19) United States
(12) Patent Application Publication
(10) Pub. No.: US 2017/0276086 A1
(43) Pub. Date: Sep. 28, 2017

(54) DEVICE AND METHOD FOR CONTROLLING OF A VALVE

(71) Applicant: HYUNDAI MOTOR COMPANY, SEOUL (KR)

(72) Inventor: Soojin KIM, Gunpo-si (KR)

(73) Assignee: HYUNDAI MOTOR COMPANY, SEOUL (KR)

(21) Appl. No.: 15/228,096

(22) Filed: Aug. 4, 2016

(30) Foreign Application Priority Data
Mar. 25, 2016 (KR) 10-2016-0035921

(51) Int. Cl. F02D 41/38; F02D 41/22; F02D 41/16

(52) U.S. Cl. CPC F02D 41/3836; F02D 41/16; F02D 41/221; F02D 2041/225

(57) ABSTRACT

Methods for controlling a Methods for controlling a valve disposed at an engine of a vehicle are disclosed. In one form of the disclosure, the method includes: determining whether an engine is an idle state; measuring a fuel pressure of the engine when the engine is the idle state; comparing the measured fuel pressure with a first threshold value; and operating the valve by applying a current to a valve operation coil when the measured fuel pressure is equal to or less than the first threshold value for a predetermined time or longer.

### CROSS-REFERENCE TO RELATED APPLICATION

The present application claims priority to, and the benefit of, Korean Patent Application No. 10-2016-0035921, filed in the Korean Intellectual Property Office on Mar. 25, 2016, the entire contents of which are incorporated herein by reference.

### BACKGROUND

(a) Field of the Disclosure

The present disclosure relates to a device for controlling a valve, and a method for controlling a valve using the same.

(b) Description of the Related Art

In general, a vehicle draws external air therein, mixes the air with fuel, and supplies the mixture to an engine, and the engine generates the power required to drive the vehicle by combusting the mixture of air and fuel.

The fuel system includes a fuel pump and a fuel filter disposed on a fuel supply line for supplying fuel from a fuel tank. An overflow valve is disposed on a fuel return line for maintaining fuel pressure in a cylinder head.

When foreign materials are burned in the valve disposed on the fuel return line, the power of the engine may deteriorate due to the fuel pressure of the cylinder head is reduced.

The above information disclosed in this Background section is only for enhancement of understanding of the background of the invention and therefore it may contain information that does not form the prior art that is already known in this country to a person of ordinary skill in the art.

### SUMMARY

The present disclosure has been made in an effort to provide a device for controlling a valve, having advantages of controlling a valve disposed in the fuel return line of the engine.

An exemplary form of the present disclosure provides a method for controlling a valve disposed at an engine of a vehicle, the method including: determining whether the engine is an idle state; measuring a fuel pressure of the engine when the engine is the idle state; comparing the measured fuel pressure with a first threshold value; and operating the valve by applying a current to a valve operation coil when the measured fuel pressure is equal to or less than the first threshold value for a predetermined time or longer.

The measuring of the fuel pressure may include measuring a fuel pressure of a fuel return line of the engine.

The operating of the valve may include supplying the current to the valve operation coil so that the valve is repeatedly opened and closed.

The method may further include comparing the measured fuel pressure with a second threshold value, and determining that at least one of a malfunction of a valve, a malfunction of a fuel pump, or a fuel leakage has occurred when the measured fuel pressure is equal to or less than the second threshold value for a predetermined time or longer.

The method may further include counting an operation number of the valve and comparing the operation number of the valve with a predetermined value; and determining that foreign materials are burned in the valve when the operation number of the valve is more than the predetermined value.

The valve may be disposed to the fuel return line to maintain a fuel pressure of a cylinder head.

An exemplary form of the present disclosure provides a device for controlling a valve, including: a pressure measuring unit configured to measure a fuel pressure of an engine; and a controller configured to measure the fuel pressure by determining whether the engine is an idle state, determining whether or not the valve is normal or abnormal by comparing the measured fuel pressure with a threshold value, and controlling an operation of the valve by supplying a current to a valve operation coil.

The device may further include a valve driver configured to supply the current to the valve operation coil so that the valve is repeatedly opened and closed.

The controller may include a comparing unit configured to compare the measured fuel pressure with the threshold value; and a determining unit configured to determine whether the valve is abnormal or in a failure state according to a result of the comparison.

The determining unit may determine that an error has occurred in the valve when the measured fuel pressure is between a first threshold value and a second threshold value, and the determining unit may determine that at least one of a malfunction of the valve, a malfunction of a fuel pump, or a fuel leakage has occurred when the measured fuel pressure is equal to or less than the second threshold value for a predetermined time or longer.

The determining unit may count an operation number of the valve, and determine that foreign materials are burned in the valve when the operation number of the valve is more than a predetermined value.

The valve may be disposed to a fuel return line to maintain a fuel pressure of a cylinder head.

In forms of the present disclosure, by determining whether the valve is abnormal by comparing the measured fuel pressure with the threshold valve when the engine is in an idle state, and by controlling the valve to be repeatedly opened and closed by supplying the current to the valve operation coil, it is possible to prevent malfunction in the valve disposed to the fuel return line due to foreign materials.

### BRIEF DESCRIPTION OF THE DRAWINGS

FIG. 1 is a FIG. 1 is a schematic diagram of a device for controlling a valve.

FIG. 2 is a flowchart briefly showing a process of for controlling valve by measuring a fuel pressure.

FIG. 3 is a graph for determining whether an error has occurred by using a fuel pressure.

FIG. 4 is a graph showing a current supplied to a valve operation coil to repeatedly operate a valve with an opened state and a closed state.

FIG. 5 is a diagram showing a valve in a closed state since a current is not supplied to a valve operation coil in FIG. 4.

FIG. 6 is a diagram showing a valve is in an opened state since a current is supplied to a valve operation coil in FIG. 4.

### DETAILED DESCRIPTION

In the following detailed description, only certain exemplary forms of the present disclosure have been shown and described, simply by way of illustration. As those skilled in the art would realize, the described forms may be modified in various different ways, all without departing from the spirit or scope of the present disclosure.

Throughout the specification, unless explicitly described to the contrary, the word “comprise” and variations such as “comprises” or “comprising” will be understood to imply the inclusion of stated elements but not the exclusion of any other elements.

Parts indicated by like reference numerals are the same components throughout the specification.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, and other alternative fuel vehicles (e.g., fuel derived from resources other than petroleum).

In addition, some methods may be executed by at least one controller. The term “controller” refers to a hardware device including a memory and a processor configured to execute one or more steps interpreted as an algorithm structure. The memory stores algorithm steps, and the processor specifically executes the algorithm steps to perform one or more processes to be described below.

Further, control logic of the present disclosure may be implemented by a non-transient computer-readable medium on a computer-readable means including executable program instructions executed by a processor, a controller, or the like. Examples of a computer-readable medium, although not restrictive, include ROMs, RAMs, CD-ROMs, magnetic tapes, floppy disks, flash drives, smart cards, and optical data storages. The computer-readable recording medium may be distributed in a network-connected computer system, and for example, may be stored and executed in a distributed manner by a telematics server or Controller Area Network (CAN).

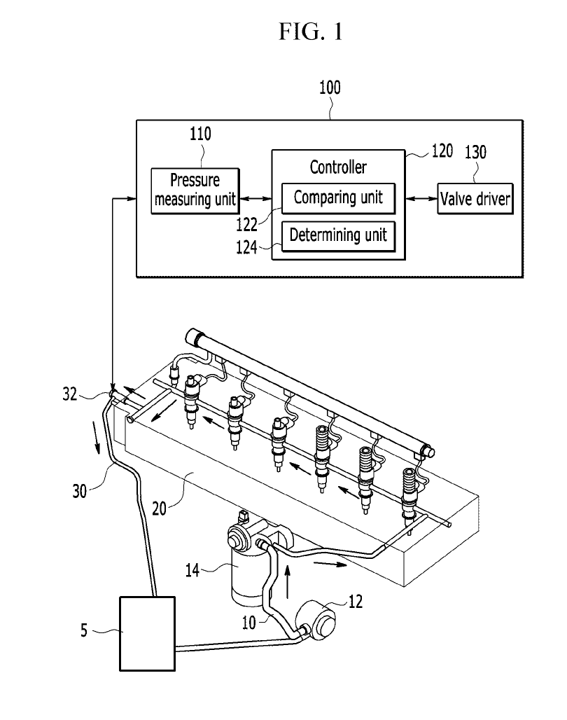

A device and method for controlling valve will now be described with reference to FIG. 1 to FIG. 6.

FIG. 1 is a schematic diagram of a device for controlling a valve. In this case, for convenience of explanation, a configuration of the device for controlling a valve is schematically illustrated, but the diesel engine is not limited thereto.

Referring to FIG. 1, a fuel supply line 10 supplies a fuel from the fuel tank 5 to the engine. An unreacted fuel of the engine is returned to the fuel tank 5 through a fuel return line 30. Herein, the fuel supply line 10 supplies the fuel to a cylinder head 20 of the engine through a fuel pump 12 and a fuel filter 14. And, fuel return line 30 includes a valve 32 for maintaining the fuel pressure in the cylinder head 20.

Referring to FIG. 1, the device for controlling a valve 100 includes a pressure measuring unit 110, a controller 120 and a valve driver 130.

The pressure measuring unit 110 measures the fuel pressure of the engine when the engine is in an idle state, and provides the measured pressure to the controller 120. The pressure measuring unit 110 may measure the fuel pressure of at least one of the fuel supply line 10, the cylinder head 20 or the fuel return line 30.

The controller 120 determines whether the engine is in the idle state and controls the pressure measuring unit 110 to measure the pressure. And, the controller 120 determines whether the valve is abnormal by comparing the fuel pressure measured by the pressure measuring unit 110 with a threshold value.

In addition, the controller 120 controls the operation of the valve by supplying a current to a valve operation coil. Herein, the valve includes the valve 32 disposed on the fuel return line 30 for maintaining the fuel pressure in the cylinder head.

For such an object, the controller 120 may be implemented with at least one processor operating by a predetermined program, and the predetermined program may be programmed to perform each step according to a method for controlling a valve according to exemplary forms of the present disclosure.

The controller 120 includes a comparing unit 122 and a determining unit 124.

The comparing unit 122 compares the fuel pressure measured by pressure measuring unit 110 with the threshold value.

The determining unit 124 determines whether the valve is abnormal or in a failure state as a result of the comparison of the comparing unit 122.

The determining unit 124 determines that an error has occurred in the valve when the measured fuel pressure is equal to or less than a first threshold value for more than a predetermined time. And, the determining unit 124 determines that the valve is broken when the measured fuel pressure is equal to or less than a second threshold value for more than a predetermined time.

The valve driver 130 supplies the current to the valve operation coil, and controls the current so that the valve is repeatedly opened and closed.

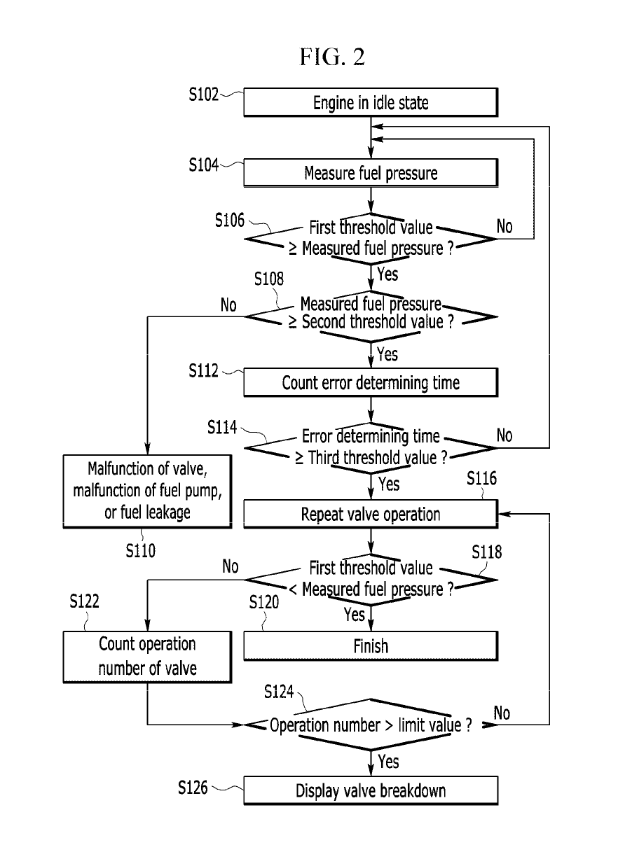

FIG. 2 is a flowchart briefly showing a process of for controlling a valve by measuring a fuel pressure. The following flowchart will be described with the same reference numerals as that of a configuration of FIG. 1.

Referring to FIG. 2, the device for controlling valve 100 measures the fuel pressure of the engine when the engine is driven and is in an idle state at steps S102 and S104. The device for controlling a valve 100 may measure the fuel pressure of at least one of the fuel supply line 10, the cylinder head 20 or the fuel return line 30.

The device for controlling a valve 100 compares the measured pressure with the threshold value and determines whether the valve is abnormal or in a failure state at steps S106 and S108.

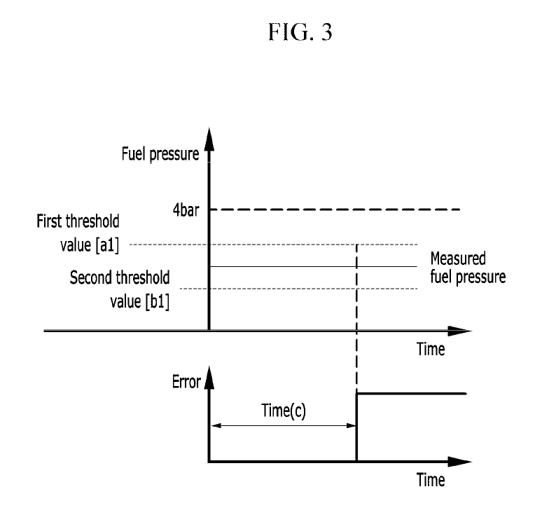

FIG. 3 is a graph for determining whether an error has occurred by using a fuel pressure.

Referring to FIG. 3, the device for controlling a valve 100 compares the measured fuel pressure with the first threshold value a1 and the second threshold value b1.

The device for controlling a valve 100 counts an amount of time when the measured pressure is between the first threshold value and the second threshold value, and determines whether the valve is abnormal by comparing the time with the third threshold value at steps S112 and S114.

For example, the device for controlling a valve 100 determines that foreign materials are burned and an error has occurred in the valve when the measured fuel pressure is less than a first threshold value a1 but greater than the second threshold value b1 for a predetermined time c1 or longer.

Also, the device for controlling a valve 100 determines that a malfunction of the valve, a malfunction of the fuel pump, or a fuel leakage has occurred when the measured fuel pressure is equal to or less than the second threshold value b1 for a predetermined time c1 or longer at step S110.

The device for controlling a valve 100 supplies the current to the valve operation coil so that the valve is repeatedly opened and closed when the error has occurred in the valve due to foreign materials at step S116.

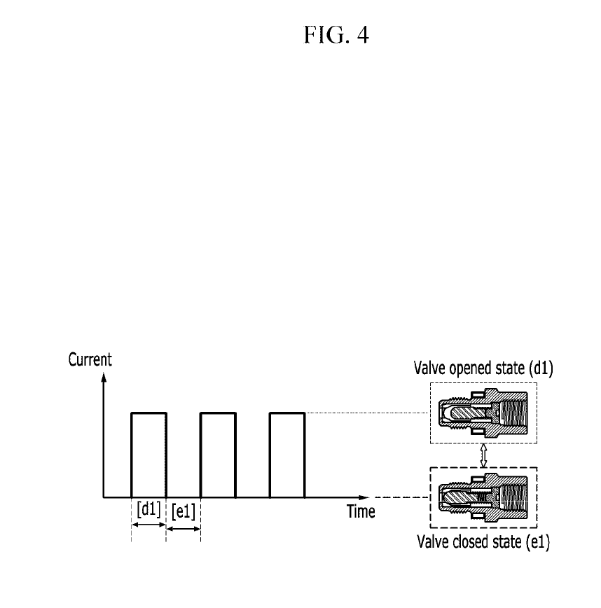

FIG. 4 is a graph showing a current supplied to a valve operation coil to repeatedly operate a valve with an opened state and a closed state.

Referring to FIG. 4, the device for controlling a valve 100 controls the valve to be in an opened state d1 by supplying the current to the valve operation coil, and controls the valve to be in a closed state e1 by stopping the supply of the current to the valve operation coil.

The device for controlling a valve 100 controls the valve to repeat the opened state d1 and the closed state e1 by supplying the current to the valve operation coil, and removes the foreign materials burned in the valve.

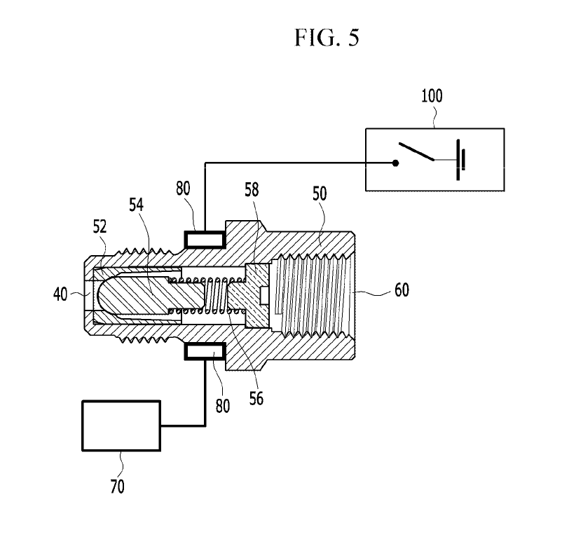

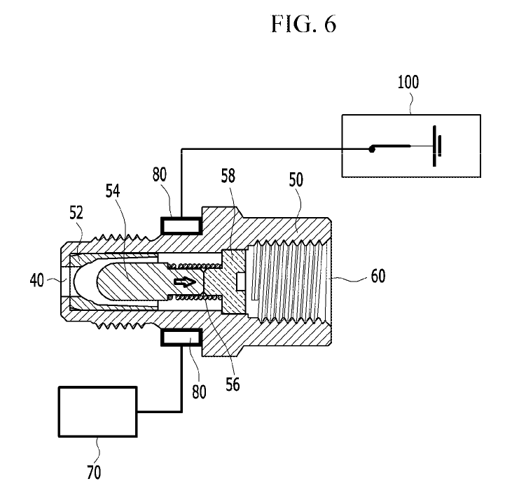

FIG. 5 is a diagram showing a valve in a closed state since a current is not supplied to a valve operation coil in FIG. 4, and FIG. 6 is a diagram showing a valve is in an opened state since a current is supplied to a valve operation coil in FIG. 4.

Referring to FIG. 5 and FIG. 6, the valve disposed on the fuel return line 30 includes a valve guide 52, a solenoid valve 54, a spring 56, a stopper 58, a body 60 and a valve operation coil 80.

As shown in FIG. 6, the device for controlling a valve 100 supplies the current to the valve operation coil 80 through the battery 70, and then the solenoid valve 54 moves along the valve guide 52 and the fuel inlet 40 is opened. If the fuel inlet 40 is opened, the fuel of the cylinder head 20 is returned to the fuel return line 30 via the fuel inlet 40 and fuel outlet 60.

Therefore, as shown in FIG. 4, the device for controlling a valve 100 repeatedly supplies the current to the valve operation coil 80. Accordingly, as shown in FIG. 5 and FIG. 6, the valve is repeated in the opened state d1 and the closed state e1, and the foreign materials burned in the valve is removed.

After repeating the operation of the valve, the device for controlling a valve 100 again measures the fuel pressure and compares the measured pressure with the first threshold value a1 at steps S118 and S120.

When the measured pressure in step S218 is less than the first threshold value a1, an operation number of the valve is counted, and the operation number of the valve is compared with a limit value at step S122. When the accumulated operation number is greater than the limit value, the device for controlling a valve 100 determines that foreign materials is burned in the valve at steps S124 and S126.

As described, the device for controlling a valve according to exemplary forms of the present disclosure determine whether the valve is abnormal by comparing the measured fuel pressure with the threshold valve when the engine is in the idle state, and controls the valve to be repeatedly opened and closed by supplying the current to the valve operation coil. Therefore, it is possible to prevent malfunction in the valve disposed to the fuel return line due to foreign materials.

The foregoing exemplary forms of the present disclosure are not implemented only by an apparatus and a method, and therefore may be realized by programs realizing functions corresponding to the configuration of the exemplary forms of the present disclosure or recording media on which the programs are recorded.

While this disclosure has been described in connection with what is presently considered to be practical exemplary forms, it is to be understood that the disclosure is not limited to the disclosed forms, but, on the contrary, is intended to cover various modifications and equivalent arrangements included within the spirit and scope of the appended claims.

What is claimed is:

1. A method for controlling a valve disposed at an engine of a vehicle, the method comprising:
determining whether the engine is an idle state;
measuring a fuel pressure of the engine when the engine is the idle state;
comparing the measured fuel pressure with a first threshold value; and
operating the valve by applying a current to a valve operation coil when the measured fuel pressure is equal to or less than the first threshold value for at least a predetermined time or longer.

2. The method of claim 1, wherein the measuring of the fuel pressure includes measuring a fuel pressure of a fuel return line of the engine.

3. The method of claim 2, wherein the operating of the valve includes supplying the current to the valve operation coil so that the valve is repeatedly opened and closed.

4. The method of claim 1, further comprising;
comparing the measured fuel pressure with a second threshold value; and
determining that at least one of a malfunction of a valve, a malfunction of a fuel pump, or a fuel leakage has occurred when the measured fuel pressure is equal to or less than the second threshold value for a predetermined time or longer.

5. The method of claim 3, further comprising;
counting an operation number of the valve and comparing the operation number of the valve with a predetermined value; and
determining that foreign materials are burned in the valve when the operation number of the valve is more than the predetermined value.

6. The method of claim 5, wherein the valve is disposed to the fuel return line to maintain a fuel pressure of a cylinder head.

7. A device for controlling a valve, comprising:
a pressure measuring unit configured to measure a fuel pressure of an engine; and
a controller configured to measure the fuel pressure by determining whether the engine is in an idle state, determining whether or not the valve is normal or abnormal by comparing the measured fuel pressure with a threshold value, and controlling an operation of the valve by supplying a current to a valve operation coil.

8. The device of claim 7, further comprising
a valve driver configured to supply the current to the valve operation coil so that the valve is repeatedly opened and closed.

9. The device of claim 8, wherein the controller includes:
a comparing unit configured to compare the measured fuel pressure with the threshold value; and
a determining unit configured to determine whether the valve is abnormal or in a failure state according to a result of the comparison.

10. The device of claim 9, wherein the determining unit is configured to determine that an error has occurred in the valve when the measured fuel pressure is between a first threshold value and a second threshold value, and is configured to determine that at least one of a malfunction of the valve, a malfunction of a fuel pump, or a fuel leakage has occurred when the measured fuel pressure is equal to or smaller than the second threshold value for a predetermined time or longer.

11. The device of claim 10, wherein the determining unit is configured to count an operation number of the valve, and to determine that foreign materials are burned in the valve when the operation number of the valve is more than a predetermined value.

12. The device of claim 11, wherein the valve is disposed to a fuel return line to maintain a fuel pressure of a cylinder head.
